(19) United States
(12) Patent Application Publication
(10) Pub. No.: US 2019/0291270 A1
(43) Pub. Date: Sep. 26, 2019

(54) CONTROLLER, MACHINE LEARNING DEVICE, AND SYSTEM

(71) Applicant: Fanuc Corporation, Minamitsuru-gun (JP)

(72) Inventor: Yuuichirou Kiyama, Minamitsuru-gun (JP)

(73) Assignee: Fanuc Corporation, Minamitsuru-gun (JP)

(21) Appl. No.: 16/294,401

(22) Filed: Mar. 6, 2019

(30) Foreign Application Priority Data
Mar. 20, 2018 (JP) 2018-053409
Jan. 8, 2019 (JP) 2019-001285

(51) Int. Cl. B25J 9/16; B25J 11/00

(52) U.S. Cl. CPC B25J 9/163; B25J 11/0065; G05B 2219/33321; G05B 2219/45058; B25J 9/1653

(57) ABSTRACT

A controller that controls a robot that performs grinding on a workpiece includes a machine learning device that learns grinding conditions for performing the grinding. The machine learning device observes, as state variables expressing a current state of an environment, a feature of a surface state of the workpiece after the grinding and the grinding conditions, acquires determination data indicating an evaluation result of the surface state of the workpiece after the grinding, and learns the feature of the surface state of the workpiece after the grinding and the grinding conditions in association with each other using the observed state variables and the acquired determination data.

### RELATED APPLICATIONS

The present application claim priority to Japanese Patent Application Number 2018-053409 filed Mar. 20, 2018 and Japanese Patent Application Number 2019-001285 filed Jan. 8, 2019, the disclosures of which are hereby incorporated by reference herein in its entirety.

### BACKGROUND OF THE INVENTION

### 1. Field of the Invention

The present invention relates to a controller, a machine learning device, and a system and, in particular, to a controller, a machine learning device, and a system that optimize grinding quality.

### 2. Description of the Related Art

Conventionally, when a robot performs a grinding operation on a machine component or the like, the operation of confirming grinding quality generally depends on person's visual observation. In addition, in order to improve the grinding quality, it is necessary to repeatedly perform test grinding while changing various conditions such as action speed of the robot, the pressing force, and the number of rotations and torque of a grinding tool.

Japanese Patent Application Laid-open No. 07-246552 describes a deburring robot that alternately performs the measurement action of measuring remaining burr height with a sensor and a grinding action. Japanese Patent Application Laid-open No. 05-196444 describes a method in which an examination robot monitors defects in a surface state of a workpiece using an imaging unit.

In order to obtain desired grinding quality by manual trial and error, it is necessary to take a lot of trouble and times. In this regard, neither Japanese Patent Application Laid-open No. 07-246552 nor Japanese Patent Application Laid-open No. 05-196444 disclose a specific technological unit for automatically optimizing grinding quality.

### SUMMARY OF THE INVENTION

In view of the above circumstances, it has been desired to provide a controller, a machine learning device, and a system that optimize grinding quality.

A controller according to a mode of the present invention controls a robot that performs grinding on a workpiece. The controller includes a machine learning device that learns grinding conditions for performing the grinding. The machine learning device has a state observation section that observes, as state variables expressing a current state of an environment, a feature of a surface state of the workpiece after the grinding and the grinding conditions, a determination data acquisition section that acquires determination data indicating an evaluation result of the surface state of the workpiece after the grinding, and a learning section that learns the feature of the surface state of the workpiece after the grinding and the grinding conditions in association with each other using the state variables and the determination data.

The grinding conditions among the state variables may include at least one of rotation speed of a grinding tool, rotation torque of the grinding tool, pressing force of the grinding tool, and action speed of the robot, and the determination data may include at least one of density D1 of streaks on the surface of the workpiece after the grinding, smoothness D2 of the streaks, and an interval D3 between the streaks.

The learning section may have a reward calculation section that calculates a reward associated with the evaluation result, and a value function update section that updates, using the reward, a function expressing a value of the grinding conditions with respect to the feature of the surface state of the workpiece after the grinding.

The learning section may have an error calculation section that calculates an error between a correlation model for deriving the grinding conditions for performing the grinding from the state variables and the determination data, and a correlation feature identified from teacher data prepared in advance, and a model update section that updates the correlation model so as to reduce the error.

The controller may further include a decision-making section that outputs a command value based on the grinding conditions on the basis of a learning result of the learning section.

The learning section may learn the grinding conditions using the state variables and the determination data obtained from a plurality of the robots.

The machine learning device may be realized by an environment of cloud computing, fog computing, or edge computing.

A machine learning device according to a mode of the present invention learns grinding conditions for performing grinding on a workpiece by a robot. The machine learning device includes: a state observation section that observes, as state variables expressing a current state of an environment, a feature of a surface state of the workpiece after the grinding and the grinding conditions; a determination data acquisition section that acquires determination data indicating an evaluation result of the surface state of the workpiece after the grinding; and a learning section that learns the feature of the surface state of the workpiece after the grinding and the grinding conditions in association with each other using the state variables and the determination data.

A system according to a mode of the present invention is a system in which a plurality of apparatuses are connected to each other via a network. The plurality of apparatuses have the controller according to the mode described above.

In the system, the plurality of apparatuses may have a computer including a machine learning device, the computer may acquire at least one learning model generated by learning of the learning section of the controller, and the machine learning device of the computer may perform optimization or improve efficiency on the basis of the acquired learning model.

In the system, the plurality of apparatuses may have a second robot different from the first robot, and a learning result of the learning section of the controller of the first robot may be shared with the second robot.

In the system, the plurality of apparatuses may have a second robot different from the first robot, and data observed by the second robot may be available for learning by the learning section of the controller of the first robot via the network.

According to the present invention, it is possible to provide a controller and a machine learning device that optimize grinding quality.

### BRIEF DESCRIPTION OF THE DRAWINGS

FIG. 1 is a hardware configuration diagram of a controller according to an embodiment of the present invention;

FIG. 2 is a function block diagram of the controller of FIG. 1;

FIG. 3 is a function block diagram showing a first mode of the controller of FIG. 2;

FIG. 4 is a schematic flowchart showing a mode of a machine learning method performed by a learning section in a machine learning device of FIG. 3;

FIG. 5A is a diagram for describing a neuron;

FIG. 5B is a diagram for describing a neural network configured by combining the neurons of FIG. 5A together;

FIG. 6 is a function block diagram of a controller according to a second embodiment of the present invention;

FIG. 7 is a diagram showing a first mode of a system having a three-hierarchy structure including a cloud server, fog computers, and edge computers;

FIG. 8 is a function block diagram showing a second mode of the system in which the controllers of FIG. 2 are incorporated;

FIG. 9 is a function block diagram showing a third mode of the system including a plurality of robots;

FIG. 10 is a function block diagram showing a fourth mode of the system in which the controllers of FIG. 2 are incorporated;

FIG. 11 is a schematic hardware configuration diagram of a computer shown in FIG. 10;

FIG. 12 is a function block diagram showing another mode of the system in which the controllers are incorporated;

FIG. 13 is a schematic view of a robot that performs grinding;

FIG. 14 is a schematic view of the robot that performs grinding;

FIG. 15 is a diagram showing an example of a surface state of a workpiece; and

FIG. 16 is a function block diagram showing a second mode of the controller of FIG. 2.

### DETAILED DESCRIPTION OF THE PREFERRED EMBODIMENTS

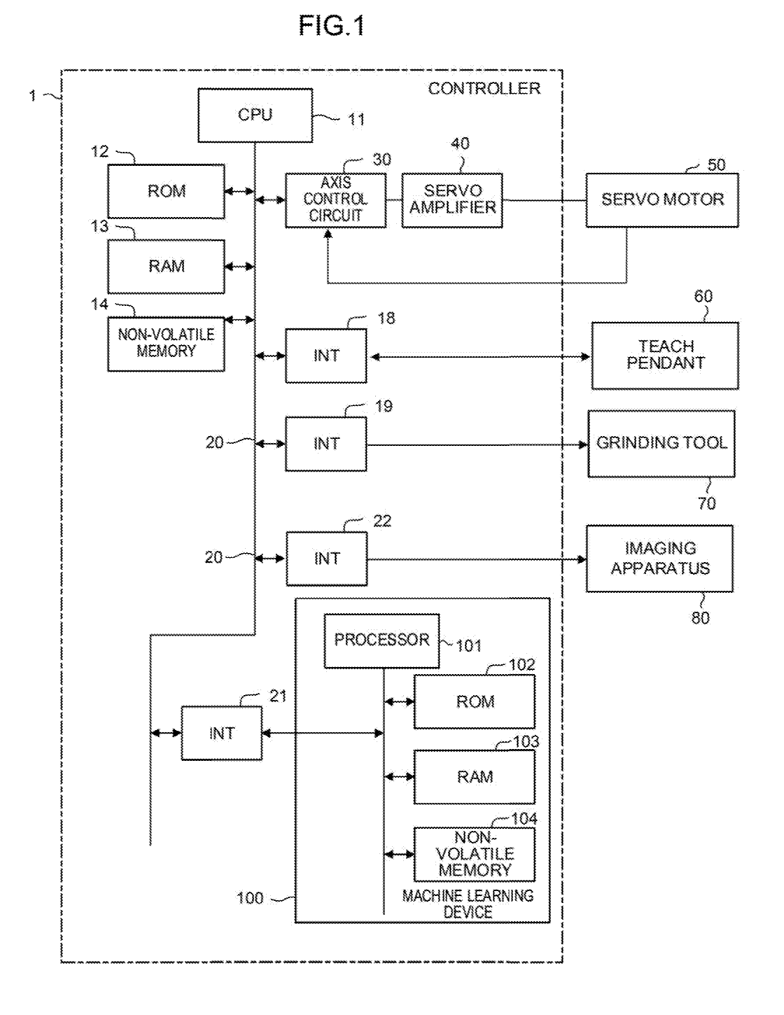

FIG. 1 is a schematic hardware configuration diagram showing a controller 1 according to an embodiment of the present invention and the essential parts of an industrial robot controlled by the controller 1. The controller 1 is a controller that controls, for example, an industrial robot (hereinafter simply called a robot) that performs grinding. The controller 1 includes a CPU 11, a ROM 12, a RAM 13, a non-volatile memory 14, an interface 18, an interface 19, an interface 21, an interface 22, a bus 20, an axis control circuit 30, and a servo amplifier 40. A servo motor 50, a teach pendant 60, a grinding tool 70, and an imaging apparatus 80 are connected to the controller 1.

The CPU 11 is a processor that entirely controls the controller 1. The CPU 11 reads a system program stored in the ROM 12 via the interface 22 and the bus 20 and controls the entire controller 1 according to the system program.

The ROM 12 stores in advance a system program for performing the various control or the like of the robot (the system program including a system program for controlling the exchange of information with a machine learning device 100 that will be described later).

The RAM 13 temporarily stores temporary calculation data or display data, data input by an operator via the teach pendant 60 that will be described later, or the like.

The non-volatile memory 14 is backed up by, for example, a battery (not shown) and maintains its storage state even if the power of the controller 1 is turned off. The non-volatile memory 14 stores data input from the teach pendant 60, a program or data for controlling the robot input via an interface (not shown), or the like. The program or the data stored in the non-volatile memory 14 may be developed into the RAM 13 when run/used.

The axis control circuit 30 controls the axis of a joint or the like of an arm of the robot. The axis control circuit 30 receives an axis movement command amount output from the CPU 11 and outputs a command for moving the axis to the servo amplifier 40.

The servo amplifier 40 receives the command for moving the axis output from the axis control circuit 30 and drives the servo motor 50.

The servo motor 50 is driven by the servo amplifier 40 to move the axis of the robot. The servo motor 50 typically includes a position and speed detector. The position and speed detector outputs a position and speed feedback signal. The signal is fed back to the axis control circuit 30 to perform the feedback control of a potion and speed.

Note that although the axis control circuit 30, the servo amplifier 40, and the servo motor 50 are only singly shown in FIG. 1, they are actually prepared for the number of axes of a robot to be controlled. For example, when a robot including six axes is controlled, totally six sets of the axis control circuits 30, the servo amplifiers 40, and the servo motors 50 corresponding to the respective axes are prepared.

The teach pendant 60 is a manual data input apparatus including a display, a handle, a hardware key, or the like. The teach pendant 60 displays information received from the CPU 11 via the interface 18 on its display screen. The teach pendant 60 transfers a pulse, a command, data, or the like input from the handle, the hardware key, or the like to the CPU 11 via the interface 18.

The grinding tool 70 is held at the tip end of the arm of the robot and grinds an object (workpiece) to be ground with a grinding stone that rotates. The grinding tool 70 performs grinding at rotation speed, rotation torque, and pressing force based on a command received from the CPU 11 via the interface 19.

The imaging apparatus 80 is an apparatus for shooting a surface state of the workpiece and is, for example, a vision sensor. The imaging apparatus 80 shoots the surface state of the workpiece according to a command received from the CPU 11 via the interface 22. The imaging apparatus 80 transfers the data of the shot image to the CPU 11 via the interface 22.

The interface 21 is an interface for connecting the controller 1 and the machine learning device 100 to each other. The machine learning device 100 includes a processor 101, a ROM 102, a RAM 103, and a non-volatile memory 104.

The processor 101 of the machine learning device 100 controls the entire machine learning device 100. The ROM 102 stores a system program or the like. The RAM 103 temporarily stores data in respective processing associated with machine learning. The non-volatile memory 104 stores a learning model or the like.

The machine learning device 100 observes various information (such as the rotation speed, the rotation torque, and the pressing force of the grinding tool 70, the action speed of the arm of the robot, and the data of an image acquired by the imaging apparatus 80) capable of being acquired by the controller 1 via the interface 21. The machine learning device 100 outputs a command for controlling the servo motor 50 or the grinding tool 70 to the controller 1 via the interface 21. The controller 1 receives the command from the machine learning device 100 and performs the correction of a command for controlling the robot or the like.

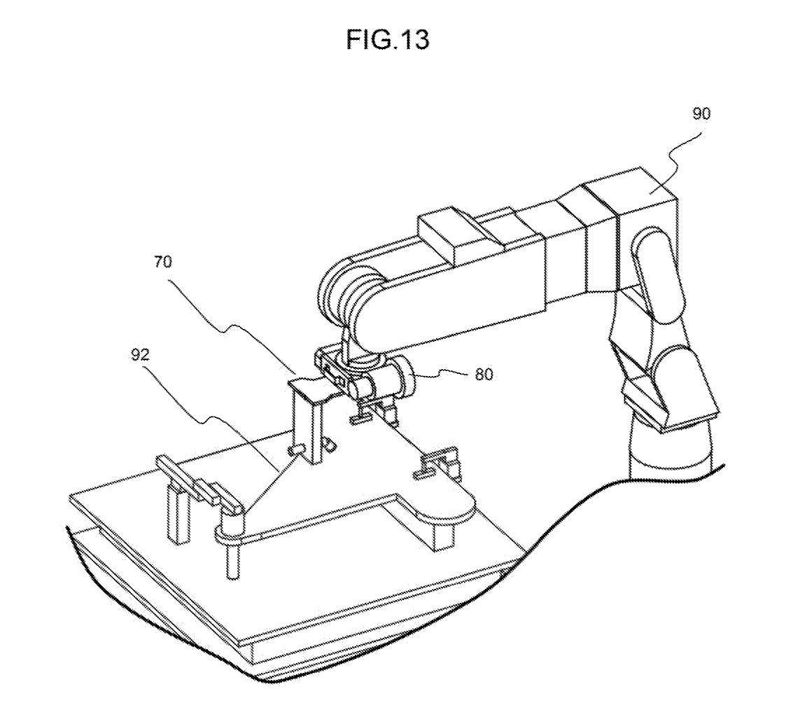

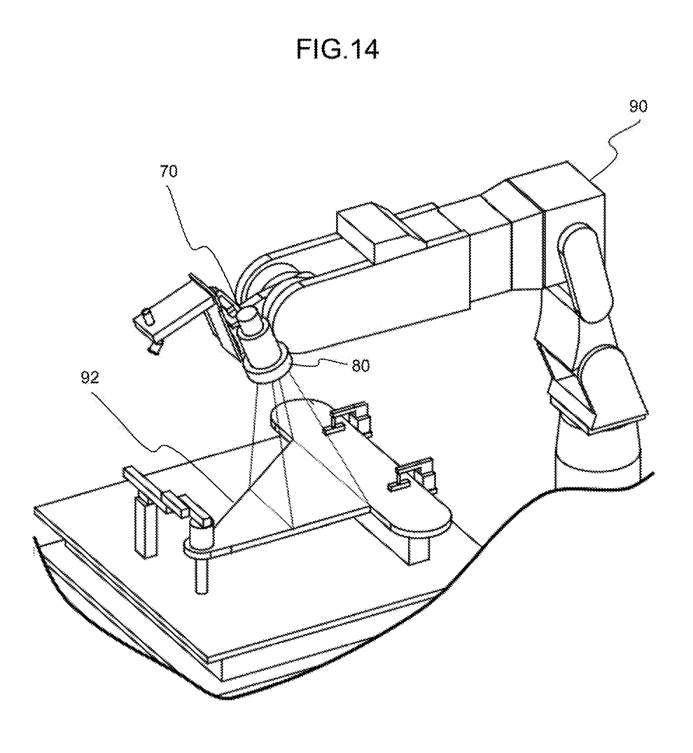

FIGS. 13 and 14 are schematic views showing an example of a robot 90 controlled by the controller 1.

The robot 90 shown in FIG. 13 includes an arm 91 that freely moves with the driving of the servo motor 50. The arm 91 includes the grinding tool 70 equipped with the imaging apparatus 80 (vision sensor) at its tip end. The grinding tool 70 grinds the surface of a workpiece 92 that is an object to be ground. After the grinding, the imaging apparatus 80 shoots a surface state of the workpiece 92 as shown in FIG. 14.

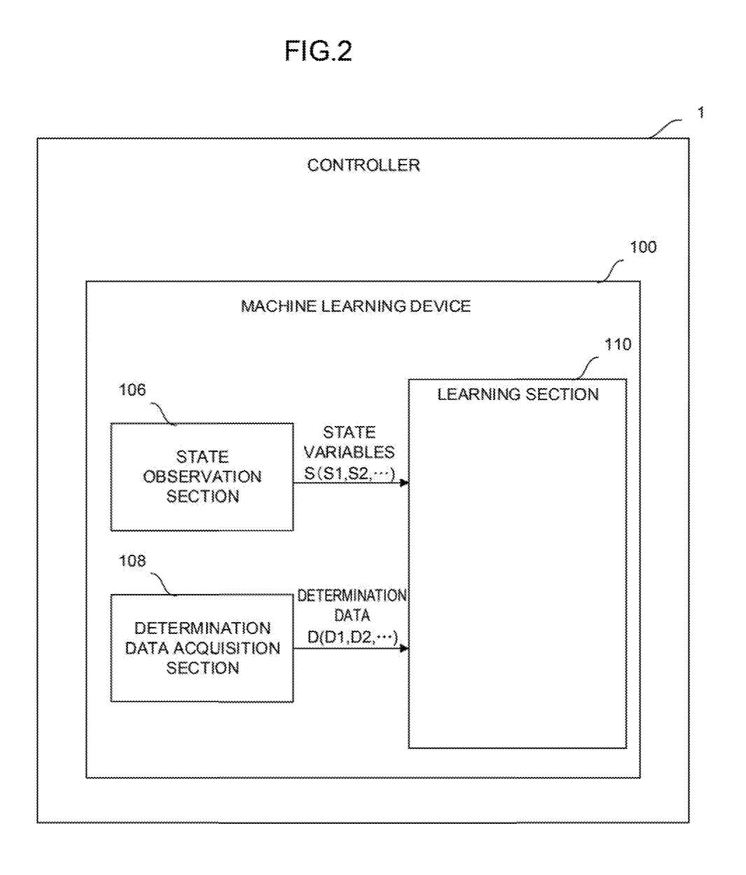

FIG. 2 is a schematic function block diagram of the controller 1 and the machine learning device 100 according to a first embodiment.

The machine learning device 100 includes a state observation section 106, a determination data acquisition section 108, and a learning section 110. For example, the state observation section 106, the determination data acquisition section 108, and the learning section 110 may be realized as one function of the processor 101 or may be realized when software stored in the ROM 102 is performed by the processor 101.

The state observation section 106 observes state variables S expressing the current state of an environment. The state variables S include rotation speed S1 of the grinding tool 70, rotation torque S2 of the grinding tool 70, pressing force S3 of the grinding tool 70, action speed S4 of an arm of a robot, and a feature S5 of a surface state of a workpiece.

The state observation section 106 acquires the rotation speed S1, the rotation torque S2, and the pressing force S3 of the grinding tool 70 from the controller 1. The controller 1 may acquire these values from a motor of the grinding tool 70 or a sensor or the like attached to the grinding tool 70.

The state observation section 106 further acquires the action speed S4 of the arm of the robot from the controller 1. The controller 1 may acquire the value from the servo motor 50 or a sensor or the like attached to the arm.

The state observation section 106 further acquires the feature S5 of the surface state of the workpiece from the controller 1. The feature S5 of the surface state of the workpiece is data indicating a feature extracted from an image of the surface state of the workpiece shot by the imaging apparatus 80 after grinding. For example, the feature S5 of the surface state of the workpiece may be acquired by the extraction of a feature amount in the image of the surface state of the workpiece according to a function of the imaging apparatus 80 or image processing software of the controller 1. The imaging apparatus 80 or the controller 1 may automatically extract a feature amount indicating the density (depth) of streaks on the surface of the workpiece, the smoothness of the streaks, the interval between the streaks, or the like according to, for example, a known method such as deep learning.

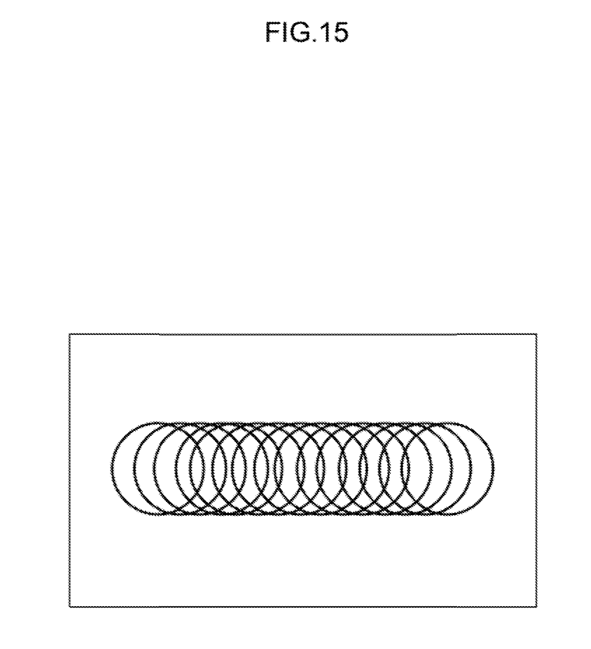

FIG. 15 shows an example of an image of the surface state of the workpiece shot by the imaging apparatus 80 after grinding. As shown in FIG. 15, streaks having various density (depth), smoothness, and intervals are left on the surface of the workpiece after the grinding. The state observation section 106 recognizes such features of the streaks from the image and extracts the same as the feature S5 of the surface state of the workpiece.

The determination data acquisition section 108 acquires determination data D that is an index indicating a result obtained when the robot performs grinding under the state variable S. The determination data D includes density D1 of streaks, smoothness D2 of the streaks, and an interval D3 between the streaks in an image of the surface state of the workpiece shot by the imaging apparatus 80 after grinding.

For example, each of the density D1 of the streaks, the smoothness D2 of the streaks, and the interval D3 between streaks may be digitized and output by the analysis of an image of the surface state of the workpiece shot by the imaging apparatus 80 after grinding according to the function of the imaging apparatus 80 or the image processing software of the controller 1. Alternatively, an operator may visually evaluate an image of the surface state of the workpiece shot by the imaging apparatus 80 after grinding and input a value (for example, “1” (=appropriate) or “0” (=inappropriate)) indicating a result of the evaluation via the teach pendant 60 to present the density D1, the smoothness D2, and the interval D3.

As a modified example, the determination data D may include rotation torque D4 of the grinding tool 70. This is because it is known that the rotation torque D4 has a correlation with the smoothness of the surface of the workpiece. In addition, the determination data D may include temperature D5 of the grinding tool 70. This is because it is known that the temperature D5 has a correlation with appropriate pressing force.

The learning section 110 learns, using the state variables S and the determination data D, the correlation between the feature S5 of the surface state of the workpiece and grinding conditions (the rotation speed S1, the rotation torque S2, and the pressing force S3 of the grinding tool 70 and the action speed S4 of the arm of the robot). That is, the learning section 110 generates a model structure indicating the correlation between the constituents S1, S2, S3, S4, and S5 of the state variables S.

In terms of the learning cycle of the learning section 110, the state variables S input to the learning section 110 are those based on data in the previous learning cycle at which the determination data D has been acquired. While the machine learning device 100 advances learning, (1) the acquisition of the feature S5 of the surface state of the workpiece, (2) the settings of the rotation speed S1, the rotation torque S2, and the pressing force S3 of the grinding tool 70 and the action speed S4 of the arm of the robot, i.e., the settings of the grinding conditions, (3) the execution of grinding according to above (1) and (2), and (4) the acquisition of the determination data D are repeatedly performed in an environment. The rotation speed S1, the rotation torque S2, and the pressing force S3 of the grinding tool 70 and the action speed S4 of the arm of the robot in (2) are the grinding conditions obtained on the basis of learning results by a previous time. The determination data D in (4) is an evaluation result of grinding performed according to the rotation speed S1, the rotation torque S2, and the pressing force S3 of the grinding tool 70 and the action speed S4 of the arm of the robot.

By repeatedly performing such a learning cycle, the learning section 110 is allowed to automatically identify a feature suggesting the correlation between the feature S5 of the surface state of the workpiece and the grinding conditions (the rotation speed S1, the rotation torque S2, and the pressing force S3 of the grinding tool 70 and the action speed S4 of the arm of the robot). Although the correlation between the feature S5 of the surface state of the workpiece and the grinding conditions (the rotation speed S1, the rotation torque S2, and the pressing force S3 of the grinding tool 70 and the action speed S4 of the arm of the robot) is substantially unknown at the start of a learning algorithm, the learning section 110 gradually identifies a feature and interprets the correlation as learning is advanced. When the correlation between the feature S5 of the surface state of the workpiece and the grinding conditions (the rotation speed S1, the rotation torque S2, and the pressing force S3 of the grinding tool 70 and the action speed S4 of the arm of the robot) is interpreted to a certain reliable extent, a learning result repeatedly output by the learning section 110 may be used to select the action (that is, decision making) of determining what grinding conditions (the rotation speed S1, the rotation torque S2, and the pressing force S3 of the grinding tool 70 and the action speed S4 of the arm of the robot) are set with respect to a current state, i.e., the feature S5 of the surface state of the workpiece. That is, the learning section 110 is allowed to output the optimum solution of the action corresponding to the current state.

The state variables S are composed of data hardly influenced by disturbance, and the determination data D is uniquely calculated when an analysis result of image data of the imaging apparatus 80 is acquired from the controller 1. Accordingly, by using a learning result of the learning section 110, the machine learning device 100 makes it possible to automatically and accurately calculate the optimum grinding conditions (the rotation speed S1, the rotation torque S2, and the pressing force S3 of the grinding tool 70 and the action speed S4 of the arm of the robot) for the current state, i.e., the feature S5 of the surface state of the workpiece without performing calculation or estimation. In other words, the optimum grinding conditions (the rotation speed S1, the rotation torque S2, and the pressing force S3 of the grinding tool 70 and the action speed S4 of the arm of the robot) may be quickly determined only by grasping the current state, i.e., the feature S5 of the surface state of the workpiece. Accordingly, the settings of the grinding conditions for grinding by the robot may be efficiently performed.

As a modified example of the machine learning device 100, the learning section 110 may learn appropriate grinding conditions common to all robots using the state variables S and the determination data D obtained for each of the plurality of robots that perform the same operation. According to the configuration, it is possible to increase an amount of a data set including the state variables S and the determination data D obtained in a certain time and input a more diversified data set. Therefore, an improvement in learning speed or reliability is allowed.

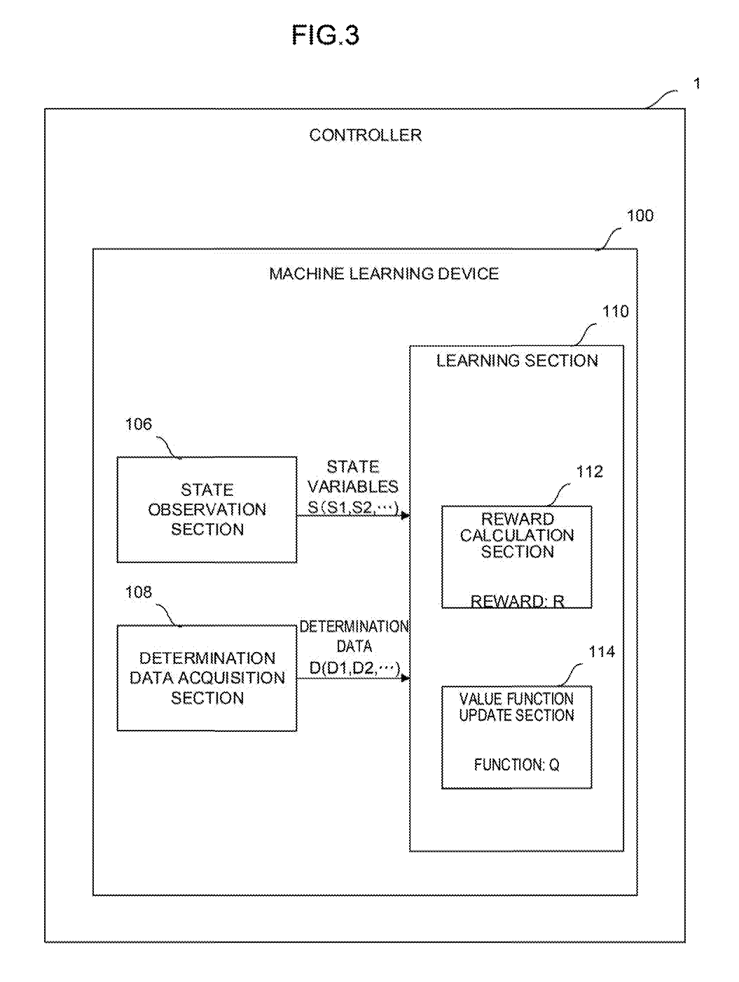

Note that a learning algorithm performed by the learning section 110 is not particularly limited. A learning algorithm known as machine learning may be employed. FIG. 3 shows, as a mode of the controller 1 shown in FIG. 2, i.e., a configuration including the learning section 110 that performs reinforcement learning as an example of a learning algorithm. The reinforcement learning is a method in which a cycle of observing the current state (that is, an input) of an environment in which a learning target exists and performing a prescribed action (that is, an output) in the current state and giving any reward to the action is repeatedly performed by trial and error to learn measures (the settings of the grinding conditions in the present embodiment) to maximize the total of the rewards as an optimum solution.

In the machine learning device 100 of the controller 1 shown in FIG. 3, the learning section 110 includes a reward calculation section 112 and a value function update section 114.

The reward calculation section 112 calculates a reward R associated with an evaluation result of grinding (corresponding to the determination data D used in the next learning cycle in which the state variables S have been acquired) when the grinding conditions are set on the basis of the state variables S.

The value function update section 114 updates, using the reward R, a function Q expressing a value of the grinding conditions. The learning section 110 learns the correlation between the feature S5 of the surface state of the workpiece and the grinding conditions (the rotation speed S1, the rotation torque S2, and the pressing force S3 of the grinding tool 70 and the action speed S4 of the arm of the robot) in such a way that the value function update section 114 repeatedly updates the function Q.

An example of a reinforcement learning algorithm performed by the learning section 110 of FIG. 3 will be described. The algorithm in this example is known as Q-learning and expresses a method in which a state s of an action subject and an action a capable of being taken by the action subject in the state s are assumed as independent variables and a function Q(s, a) expressing an action value when the action a is selected in the state s is learned. The selection of the action a by which the value function Q becomes the largest in the state s results in an optimum solution. By starting the Q-learning in a state in which the correlation between the state s and the action a is unknown and repeatedly performing the selection of various actions a by trial and error in any state s, the value function Q is repeatedly updated to be approximated to an optimum solution. Here, when an environment (that is, the state s) changes as the action a is selected in the state s, a reward (that is, weighting of the action a) r is obtained according to the change and the learning is directed to select an action a by which a higher reward r is obtained. Thus, the value function Q may be approximated to an optimum solution in a relatively short period of time.

Generally, the update formula of the value function Q may be expressed like the following formula (1). In formula (1), sₜ and aₜ express a state and an action at time t, respectively, and the state changes to sₜ₊₁ with the action aₜ. rₜ₊₁ expresses a reward obtained when the state changes from sₜ to sₜ₊₁. The term of maxQ expresses Q in a case in which an action a by which the value function Q becomes maximum at time t+1 (which is assumed at time t) is performed. α and γ express a learning coefficient and a discount rate, respectively, and arbitrarily set to fall within 0<α≤1 and 0<γ≤1, respectively.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 1 )$$

When the learning section 110 performs the Q-learning, the state variables S observed by the state observation section 106 and the determination data D acquired by the determination data acquisition section 108 correspond to the state s in the update formula, the action of determining how the grinding conditions (the rotation speed S1, the rotation torque S2, and the pressing force S3 of the grinding tool 70 and the action speed S4 of the arm of the robot) are set with respect to the current state, i.e., the feature S5 of the surface state of the workpiece corresponds to the action a in the update formula, and the reward R calculated by the reward calculation section 112 corresponds to the reward r in the update formula. Accordingly, the value function update section 114 repeatedly updates the function Q expressing a value of the settings of the grinding conditions with respect to the current state by the Q-learning using the reward R.

A value of the reward R calculated by the reward calculation section 112 may be positive, for example, when an evaluation result of grinding is determined to be “appropriate” after the grinding based on the determined grinding conditions (the rotation speed S1, the rotation torque S2, and the pressing force S3 of the grinding tool 70 and the action speed S4 of the arm of the robot) is performed. On the other hand, the value of the reward R may be negative when the evaluation result of the grinding is determined to be “inappropriate.” The absolute values of the positive and negative rewards R may be the same or different from each other.

When the determination data D is given by multiple values, the evaluation result of the grinding may be determined to be “appropriate,” for example, if the differences between the value D1 indicating the density of streaks, the value D2 indicating the smoothness of the streaks, and the value D3 indicating the interval between the streaks and reference values set for the respective values fall within prescribed ranges. On the other hand, the evaluation result of the grinding may be determined to be “inappropriate” if the differences fall outside the prescribed ranges. When the determination data D is given by two values, for example, when the values D1, D2, and D3 are given by values such as “1” (=appropriate) and “0” (=inappropriate), the evaluation result of the grinding may be determined to be “appropriate” if an input is “1” and determined to be “inappropriate” if the input is “0.”

The evaluation result of the grinding may be set not only to the “appropriate” and “inappropriate” evaluations but also to a plurality of stages of evaluations. For example, the reward calculation section 112 may decrease the reward R as the values D1, D2, and D3 are deviated from the reference values, that is, as the differences between the values D1, D2, and D3 and the reference values set for the respective values become larger.

Note that the reward calculation section 112 may combine a plurality of values included in the determination data D together to determine the propriety.

The value function update section 114 may have an action value table in which the state variables S, the determination data D, and the rewards R are organized in association with action values (for example, numeric values) expressed by the function Q. In this case, the action of updating the function Q with the value function update section 114 is equivalent to the action of updating the action value table with the value function update section 114. At the start of the Q-learning, the correlation between the feature S5 of the surface state of the workpiece and the grinding conditions (the rotation speed S1, the rotation torque S2, and the pressing force S3 of the grinding tool 70 and the action speed S4 of the arm of the robot) is unknown. Therefore, in the action value table, various kinds of the state variables S, the determination data D, and the rewards R are prepared in association with values (function Q) of randomly-set action values. Note that the reward calculation section 112 may immediately calculate the rewards R corresponding to the determination data D when the determination data D is known, and values of the calculated rewards R are written in the action value table.

When the Q-learning is advanced using the reward R corresponding to an evaluation result of the grinding, the learning is directed to select the action of obtaining a higher reward R. Then, values (function Q) of action values for an action performed in the current state are rewritten to update the action value table according to the state of the environment (that is, the state variables S and the determination data D) that changes as the selected action is performed in the current state. By repeatedly performing the update, the values (the function Q) of action values displayed in the action value table are rewritten to be larger as an action is more appropriate. Thus, the correlation between the current state in the unknown environment, that is, the feature S5 of the surface state of the workpiece and the corresponding action, that is, the set grinding conditions (the rotation speed S1, the rotation torque S2, and the pressing force S3 of the grinding tool 70 and the action speed S4 of the arm of the robot) becomes gradually obvious. That is, by the update of the action value table, the correlation between the feature S5 of the surface state of the workpiece and the grinding conditions (the rotation speed S1, the rotation torque S2, and the pressing force S3 of the grinding tool 70 and the action speed S4 of the arm of the robot) is gradually approximated to an optimum solution.

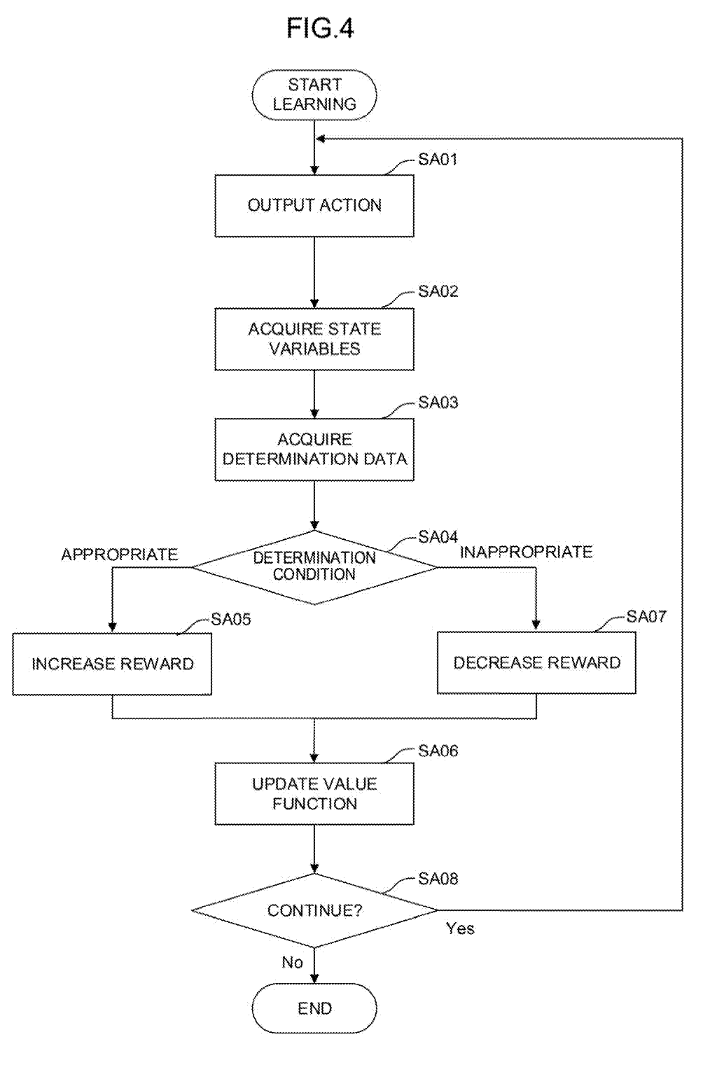

The flow of the Q-learning (that is, a mode of a machine learning method) performed by the learning section 110 of FIG. 3 will be further described with reference to FIG. 4.

Step SA01: The value function update section 114 randomly selects, by referring to an action value table at that time, the grinding conditions (the rotation speed S1, the rotation torque S2, and the pressing force S3 of the grinding tool 70 and the action speed S4 of the arm of the robot) as an action performed in a current state indicated by the state variables S observed by the state observation section 106.

Step SA02: The value function update section 114 imports the state variable S in the current state observed by the state observation section 106.

Step SA03: The value function update section 114 imports the determination data D in the current state acquired by the determination data acquisition section 108.

Step SA04: The value function update section 114 determines if the grinding conditions (the rotation speed S1, the rotation torque S2, and the pressing force S3 of the grinding tool 70 and the action speed S4 of the arm of the robot) have been appropriate on the basis of the determination data D. If the grinding conditions have been appropriate, the processing proceeds to step SA05. If the grinding conditions have not been appropriate, the processing proceeds to step SA07.

Step SA05: The value function update section 114 applies a positive reward R calculated by the reward calculation section 112 to the update formula of the function Q.

Step SA06: The value function update section 114 updates the action value table using the state variable S and the determination data D in the current state, the reward R, and a value (updated function Q) of an action value.

Step SA07: The value function update section 114 applies a negative reward R calculated by the reward calculation section 112 to the update formula of the function Q.

The learning section 110 updates the action value table over again by repeatedly performing the processing of steps SA01 to SA07 and advances the learning. Note that the processing for calculating the rewards R and the processing for updating the value function in steps SA04 to SA07 are performed for each of the data contained in the determination data D.

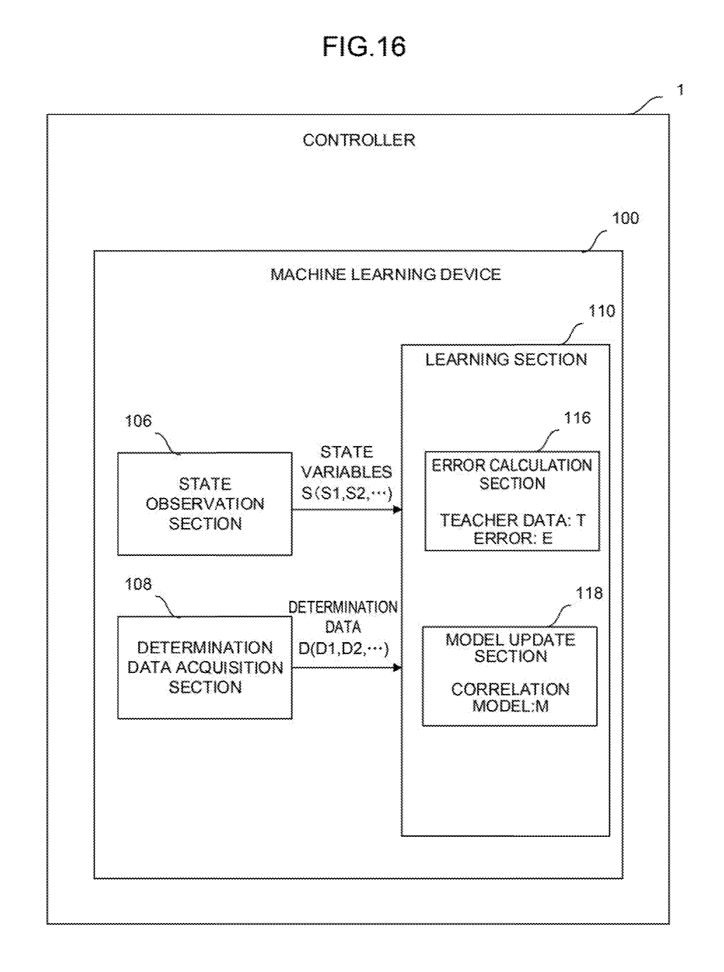

FIG. 16 shows another mode of the controller 1 shown in FIG. 2, i.e., a configuration including the learning section 110 that performs supervised learning as another example of the learning algorithm.

Unlike the above reinforcement learning in which learning is started when the relationship between an input and an output is unknown, the supervised learning is a method in which a large amount of known data sets (called teacher data) of inputs and outputs corresponding to the inputs are given in advance and a feature suggesting the correlation between the inputs and the outputs is identified from the teacher data to learn a correlation model (the grinding conditions for grinding by the robot in the machine learning device 100 of the present application) for estimating a desired output with respect to a new input.

In the machine learning device 100 shown in FIG. 16, the learning section 110 includes an error calculation section 116 and a model update section 118. The error calculation section 116 calculates an error E between a correlation model M for deriving the grinding conditions for grinding by the robot from the state variables S and the determination data D and teacher data T prepared in advance. The model update section 118 updates the correlation model M so as to reduce the error E. The learning section 110 learns the grinding conditions for grinding by the robot in such a way that the model update section 118 repeatedly updates the correlation model M.

The initial value of the correlation model M is expressed by the simplification (for example, by a primary function) of the correlation between the state variables S and the determination data D and the grinding conditions for grinding by the robot and given to the learning section 110 before the start of the supervised learning. The teacher data T may be constituted by, for example, experience values (the known data sets of the features of the surface state of the workpiece and the grinding conditions for grinding by the robot) accumulated by the recording of the grinding conditions determined by a skilled operator in past grinding, and is given to the learning section 110 before the start of the supervised learning. The error calculation section 116 identifies a correlation feature suggesting the correlation between the feature of the surface state of the workpiece and the grinding conditions for grinding by the robot from a large amount of the teacher data T given to the learning section 110, and calculates an error E between the correlation feature and the correlation model M corresponding to the state variables S and the determination data D in a current state. The model update section 118 updates the correlation model M so as to reduce the error E according to, for example, a prescribed update rule.

In the next learning cycle, the error calculation section 116 calculates the error E about the correlation model M corresponding to the changed state variables S and the determination data D using the state variables S and the determination data D changed after grinding is attempted according to the updated correlation model M, and the model update section 118 updates the correlation model M again. Thus, the correlation between the current state (the feature of the surface state of the workpiece) in an unknown environment and a corresponding action (the determination of the grinding conditions for grinding by the robot) becomes gradually obvious. That is, by the update of the correlation model M, the relationship between the feature of the surface state of the workpiece and the grinding conditions for grinding by the robot is gradually approximated to an optimum solution.

Note that, in the machine learning device 100, the learning section 110 may be configured to perform the supervised learning at the initial stage of learning and perform the reinforcement learning using the grinding conditions for grinding by the robot obtained by the supervised learning as an initial value after the learning is advanced to a certain extent. Since the initial value in the reinforcement learning has reliability to a certain extent, an optimum solution may be obtained relatively quickly.

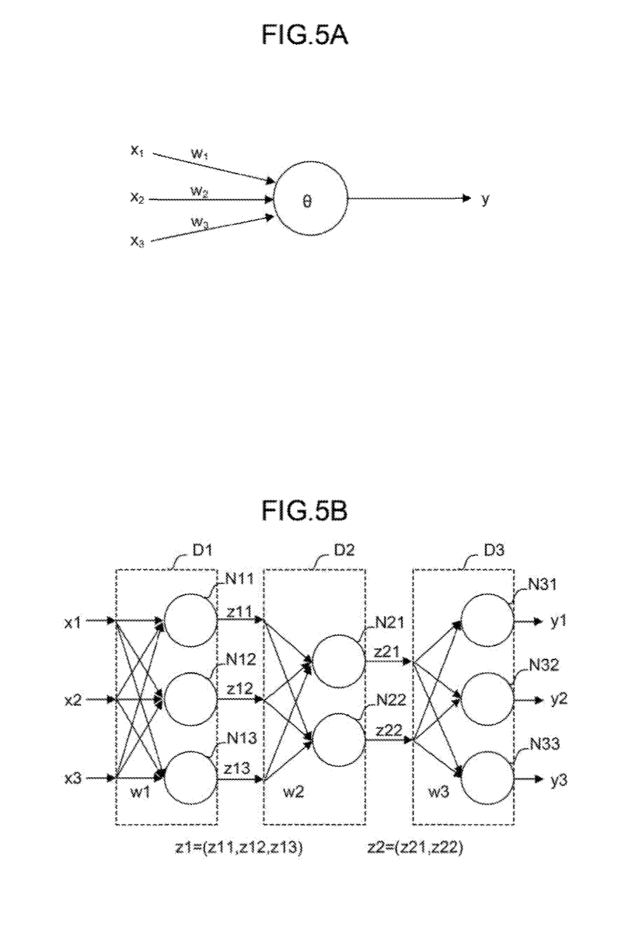

In advancing the reinforcement learning or the supervised learning, a neural network may be, for example, used instead of the Q-learning. FIG. 5A schematically shows a neuron model. FIG. 5B schematically shows the model of a neural network having three layers in which the neurons shown in FIG. 5A are combined together. The neural network may be constituted by, for example, an arithmetic unit, a storage unit, or the like following a neuron model.

The neuron shown in FIG. 5A outputs a result y with respect to a plurality of inputs x (here, inputs x₁ to x₃ as an example). The inputs x₁ to x₃ are multiplied by corresponding weights w (w₁ to w₃), respectively. Thus, the neuron outputs the result y expressed by the following formula 2. Note that in the following formula 2, an input x, a result y, and a weight w are all vectors. In addition, θ expresses a bias, and fₖ expresses an activation function.

y=fₖ(Σᵢ₌₁ⁿxᵢwᵢ−θ) (2)

In the neural network having the three layers shown in FIG. 5B, a plurality of inputs x (here, inputs x1 to x3 as an example) are input from the left side of the neural network, and results y (here, results y1 to y3 as an example) are output from the right side of the neural network. In the example shown in FIG. 5B, the inputs x1 to x3 are multiplied by corresponding weights (collectively expressed as w1) and input to three neurons N11 to N13, respectively.

In FIG. 5B, the respective outputs of the neurons N11 to N13 are collectively expressed as z1. The outputs z1 may be regarded as feature vectors obtained by extracting feature amounts of the input vectors. In the example shown in FIG. 5B, the respective feature vectors z1 are multiplied by corresponding weights (collectively expressed as w2) and input to two neurons N21 to N22, respectively. The feature vectors z1 express the features between the weights w1 and the weights w2.

In addition, the respective outputs of neurons N21 and N22 are collectively expressed as z2. The outputs z2 may be regarded as feature vectors obtained by extracting feature amounts of the feature vectors z1. In the example shown in FIG. 5B, the respective feature vectors z2 are multiplied by corresponding weights (collectively expressed as w3) and input to three neurons N31 to N33, respectively. The feature vectors z2 express the features between the weights w2 and the weight w3. Finally, the neurons N31 to N33 output the results y1 to y3, respectively.

Note that it is possible to employ so-called deep learning in which a neural network forming three or more layers is used.

In the machine learning device 100, the learning section 110 performs calculation in a multilayer structure according to a neural network with the state variables S and the determination data D as inputs x, whereby the grinding conditions (the rotation speed S1, the rotation torque S2, and the pressing force S3 of the grinding tool 70 and the action speed S4 of the arm of the robot) can be output as results y. In addition, in the machine learning device 100, the learning section 110 uses a neural network as a value function in the reinforcement learning and performs calculation in a multilayer structure according to the neural network with the state variables S and the action a as inputs x, whereby a value (result y) of a certain action in a certain state can be output. Note that the action mode of the neural network includes a learning mode and a value prediction mode. For example, it is possible to learn a weight w using a learning data set in the learning mode and determine an action value using the learned weight w in the value prediction mode. Note that detection, classification, deduction, or the like may be performed in the value prediction mode.

The configuration of the above controller 1 may be described as a machine learning method (or software) performed by the processor 101 of the machine learning device 100. The machine learning method is a method for learning the grinding conditions (the rotation speed S1, the rotation torque S2, and the pressing force S3 of the grinding tool 70 and the action speed S4 of the arm of the robot) for grinding by the robot. In the machine learning method, the CPU of a computer performs steps of

observing the feature S5 of the surface state of the workpiece as the state variables S expressing the current state of an environment in which the grinding is performed;

acquiring the determination data D indicating an evaluation result of the grinding performed according to the set grinding conditions (the rotation speed S1, the rotation torque S2, and the pressing force S3 of the grinding tool 70 and the action speed S4 of the arm of the robot); and

learning the feature S5 of the surface state of the workpiece and the grinding conditions (the rotation speed S1, the rotation torque S2, and the pressing force S3 of the grinding tool 70 and the action speed S4 of the arm of the robot) in association with each other using the state variables S and the determination data D.

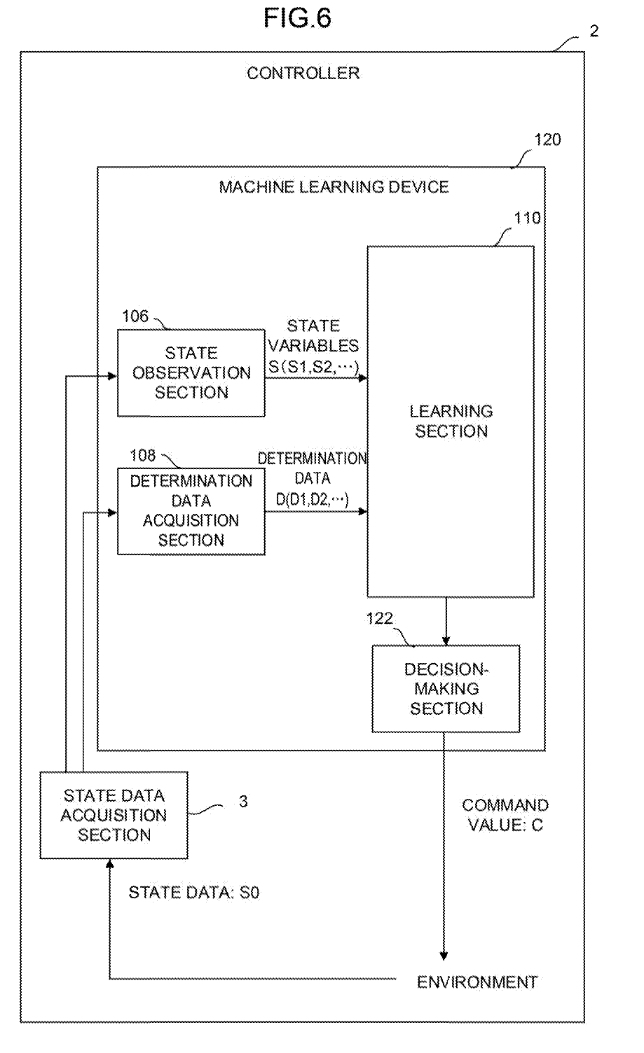

FIG. 6 shows a controller 2 according to a second embodiment of the present invention.

The controller 2 includes a machine learning device 120 and a state data acquisition section 3. The state data acquisition section 3 acquires the feature S5 of the surface state of the workpiece and the grinding conditions (the rotation speed S1, the rotation torque S2, and the pressing force S3 of the grinding tool 70 and the action speed S4 of the arm of the robot) as state data S0 and supplies the acquired feature S5 to the state observation section 106. The state data acquisition section 3 may acquire the state data S0 from, for example, the controller 2 or various devices and sensors of the robot.

The machine learning device 120 includes a decision-making section 122 in addition to the state observation section 106, the determination data acquisition section 108, and the learning section 110. The decision-making section 122 may be realized as, for example, one function of the processor 101 of the machine learning device 120. Alternatively, the decision-making section 122 may be realized, for example, when the software stored in the ROM 102 is performed by the processor 101.

In addition to software (such as a learning algorithm) and hardware (such as the processor 101) for spontaneously learning the grinding conditions (the rotation speed S1, the rotation torque S2, and the pressing force S3 of the grinding tool 70 and the action speed S4 of the arm of the robot) for grinding by the robot through machine learning, the machine learning device 120 includes software (such as a calculation algorithm) and hardware (such as the processor 101) for outputting the grinding conditions (the rotation speed S1, the rotation torque S2, and the pressing force S3 of the grinding tool 70 and the action speed S4 of the arm of the robot) calculated on the basis of a learning result as a command for the controller 2. The machine learning device 120 may have a configuration in which one common processor performs all software such as a learning algorithm and a calculation algorithm.

The decision-making section 122 generates a command value C including a command for determining the grinding conditions (the rotation speed S1, the rotation torque S2, and the pressing force of the grinding tool 70 and the action speed S4 of the arm of the robot) corresponding to the feature S5 of the surface state of the workpiece on the basis of a learning result of the learning section 110. When the decision-making section 122 outputs the command value C to the controller 2, the controller 2 controls the robot according to the command value C. Thus, the state of the environment changes.

The state observation section 106 observes the state variables S changed when the decision-making section 122 outputs the command value C to the environment in the next learning cycle. The learning section 110 updates the value function Q (that is, the action value table) using the changed state variables S to learn the grinding conditions (the rotation speed S1, the rotation torque S2, and the pressing force S3 of the grinding tool 70 and the action speed S4 of the arm of the robot) for grinding by the robot. Note that on this occasion, instead of acquiring the grinding conditions (the rotation speed S1, the rotation torque S2, and the pressing force S3 of the grinding tool 70 and the action speed S4 of the arm of the robot) from the state data S0 acquired by the state data acquisition section 3, the state observation section 106 may observe the grinding conditions from the RAM 103 of the machine learning device 120 as described in the first embodiment.

Then, the decision-making section 122 outputs the command value C for commanding the grinding conditions (the rotation speed S1, the rotation torque S2, and the pressing force of the grinding tool 70 and the action speed S4 of the arm of the robot) calculated on the basis of the learning result to the controller 2 again. By repeatedly performing the learning cycle, the machine learning device 120 advances the learning and gradually improves the reliability of the grinding conditions (the rotation speed S1, the rotation torque S2, and the pressing force of the grinding tool 70 and the action speed S4 of the arm of the robot) determined by the machine learning device 120 itself.

The machine learning device 120 shown in FIG. 6 produces the same effects as those of the machine learning device 100 of the first embodiment shown in FIG. 2. In addition, the machine learning device 120 may change the state of the environment according to the output of the decision-making section 122. Note that the machine learning device 100 makes it possible to reflect the learning result of the learning section 110 on the environment by asking a function corresponding to the decision-making section 122 for an external apparatus.

The following third to fifth embodiments will describe embodiments in which the controllers 1 and 2 according to the first and second embodiments and a plurality of apparatuses including a cloud server or a host computer, fog computers, and edge computers (such as robot controllers and controllers) are connected to each other via a wired/wireless network.

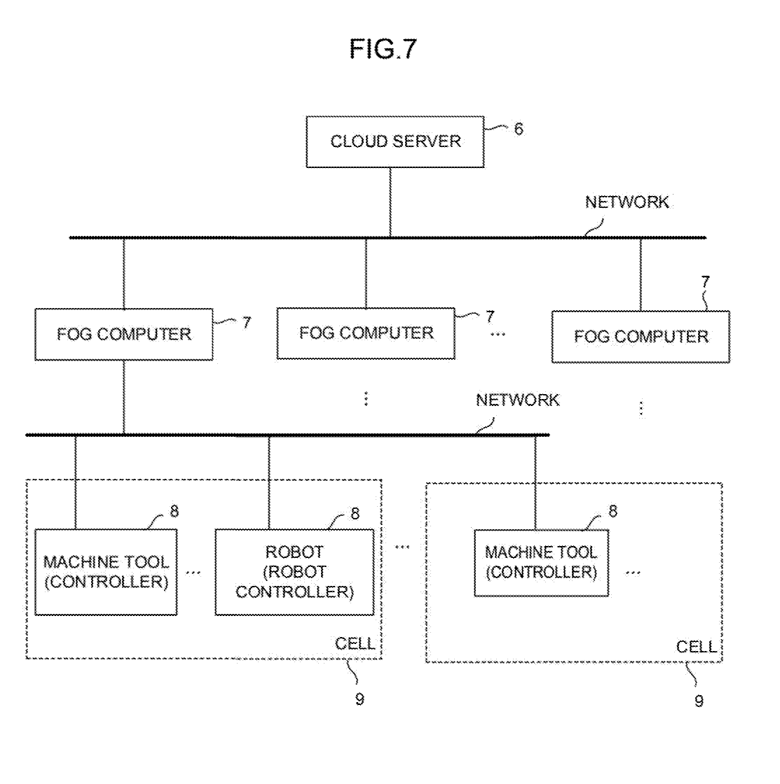

As illustrated in FIG. 7, the following third to fifth embodiments assume a system in which each of the plurality of apparatuses is configured to be logically separated into the three hierarchies of a layer including a cloud server 6 or the like, a layer including fog computers 7 or the like, and a layer including edge computers 8 (such as robot controllers and controllers included in cells 9) in a state of being connected to a network. In such a system, the controllers 1 and 2 are mountable on any of the cloud server 6, the fog computers 7, and the edge computers 8. The controllers 1 and 2 may mutually share learning data with the plurality of apparatuses via the network to perform distributed learning, collect a generated learning model in the fog computers 7 or the cloud server 6 to perform a large-scale analysis, or perform the mutual reuse of the generated learning model or the like.

In the system illustrated in FIG. 7, the plurality of cells 9 are provided in factories at various places and managed by the fog computers 7 of a higher layer for each prescribed unit (such as each factory and each of a plurality of factories of the same manufacturer). Then, data having been collected and analyzed by the fog computers 7 is collected and analyzed by the cloud server 6 of a still higher layer, and resulting information may be used for the control of the respective edge servers or the like.

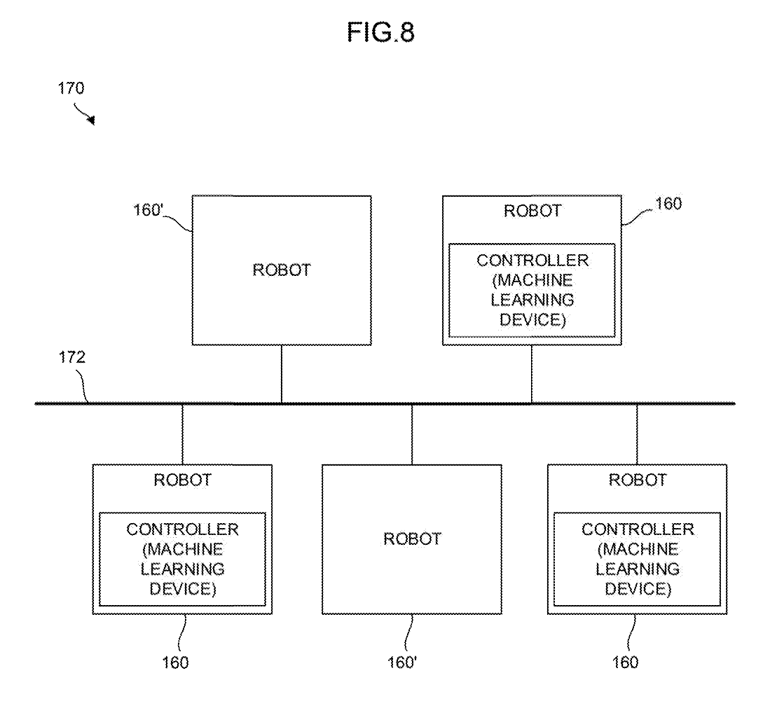

FIG. 8 shows a system 170 according to the third embodiment in which a plurality of robots are added to the controllers 1 and 2.

The system 170 includes a plurality of robots 160 and 160′. All the robots 160 and 160′ are connected to each other via a wired or wireless network 172.

The robots 160 and 160′ have a mechanism for an operation to achieve the same goal and perform the same operation. Meanwhile, the robots 160 include the controllers 1 and 2, but the robots 160′ do not include the same controllers as the controllers 1 and 2.

Using a learning result of the learning section 110, the robots 160 including the controllers 1 and 2 may automatically and accurately calculate the grinding conditions (the rotation speed S1, the rotation torque S2, and the pressing force S3 of the grinding tool 70 and the action speed S4 of the arms of the robots) corresponding to the feature S5 of the surface state of the workpiece without performing calculation or estimation. In addition, the controller 2 of at least one of the robots 160 may be configured to learn the grinding conditions (the rotation speed S1, the rotation torque S2, and the pressing force S3 of the grinding tool 70 and the action speed S4 of the arms of the robots) for grinding by the robots common to all the robots 160 and 160′ using the state variables S and the determination data D obtained for each of the plurality of robots 160 and 160′ to allow all the robots 160 and 160′ to share a result of the learning with each other. According to the system 170, it is possible to improve the learning speed or reliability of the grinding conditions (the rotation speed S1, the rotation torque S2, and the pressing force S3 of the grinding tool 70 and the action speed S4 of the arms of the robots) for grinding by the robots using a variety of data sets (including the state variables S and the determination data D) as inputs.

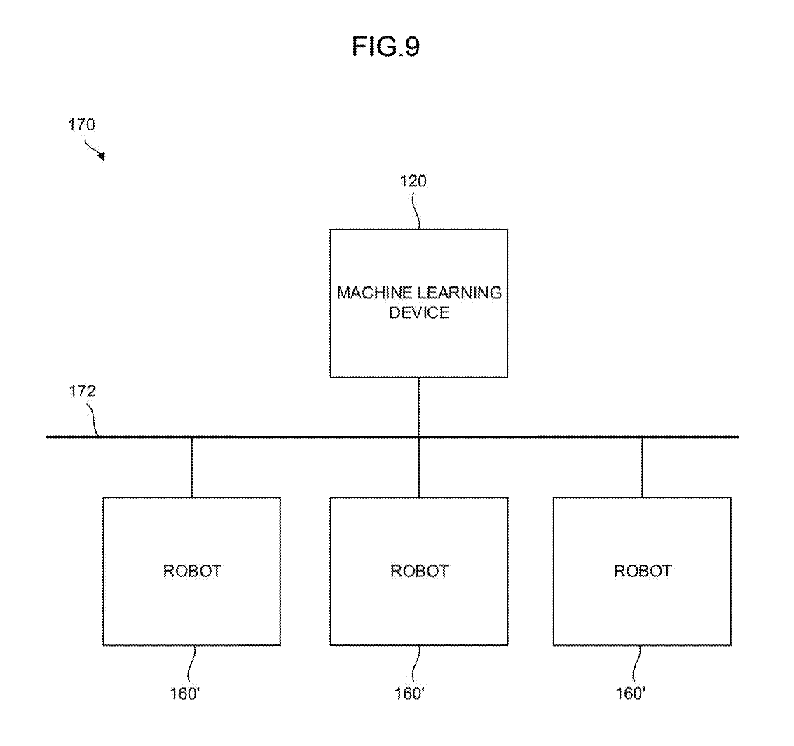

FIG. 9 shows a system 170 according to the fourth embodiment including the plurality of robots 160′.

The system 170 includes the plurality of robots 160′ having the same machine configuration and the machine learning device 120 of FIG. 6 (or the machine learning device 100 of FIG. 2). The plurality of robots 160′ and the machine learning device 120 (or the machine learning device 100) are connected to each other via the wired or wireless network 172.

The machine learning device 120 (or the machine learning device 100) learns the grinding conditions (the rotation speed S1, the rotation torque S2, and the pressing force S3 of the grinding tool 70 and the action speed S4 of the arms of the robots) for grinding by the robots common to all the robots 160′ on the basis of the state variables S and the determination data D obtained for each of the plurality of robots 160′. Using a result of the learning, the machine learning device 120 (or the machine learning device 100) may automatically and accurately calculate the grinding conditions (the rotation speed S1, the rotation torque S2, and the pressing force S3 of the grinding tool 70 and the action speed S4 of the arms of the robots) corresponding to the feature S5 of the surface state of the workpiece without performing calculation or estimation.

The machine learning device 120 (or the machine learning device 100) may be mounted on a cloud server, a fog computer, an edge computer, or the like. According to the configuration, a required number of the robots 160′ may be connected to the machine learning device 120 (or the machine learning device 100) as occasion demands regardless of the existing locations or times of the plurality of robots 160′.

The system 170 or an operator managing the system 170 may perform a determination as to whether the achievement degree of the learning of the grinding conditions (the rotation speed S1, the rotation torque S2, and the pressing force S3 of the grinding tool 70 and action speed S4 of the arms of the robots) by the machine learning device 120 (or the machine learning device 100) (i.e., the reliability of the output grinding conditions (the rotation speed S1, the rotation torque S2, and the pressing force S3 of the grinding tool 70 and action speed S4 of the arms of the robots)) have reached a requested level at an appropriate time after the start of learning by the machine learning device 120 (or 100).

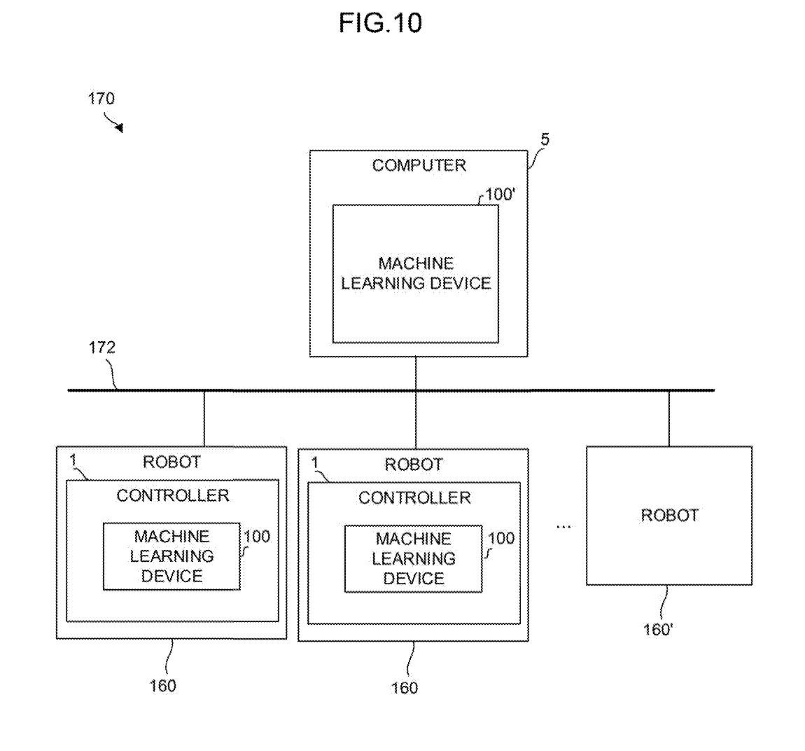

FIG. 10 shows the system 170 according to the fifth embodiment including the controllers 1.

The system 170 includes at least one machine learning device 100′ mounted on a computer 5 such as an edge computer, a fog computer, a host computer, and a cloud server, at least the one controller 1 mounted as a controller (edge computer) that controls the robot 160, and the wired/wireless network 172 that connects the computer 5 and the robots 160 to each other.

In the system 170 having the above configuration, the computer 5 including the machine learning device 100′ acquires learning models obtained as results of machine learning by the machine learning devices 100 of the controllers 1 from the controllers 1 that control the respective robots 160. Then, the machine learning device 100′ of the computer 5 performs processing for optimizing or improving the efficiency of knowledge based on the plurality of learning models to newly generate a learning model optimized or made efficient and distributes the generated learning model to the controllers 1 that control the respective robots 160.

As an example of optimizing or improving the efficiency of the learning models performed by the machine learning device 100′, it is assumed to generate a distillation model based on the plurality of learning models acquired from the respective controllers 1. In this case, the machine learning device 100′ according to the present embodiment generates input data to be input to the learning models and newly performs learning using outputs obtained as a result of the input of the input data to the respective learning models to newly generate the learning model (distillation model). As described above, the distillation model thus generated is more preferably distributed to other computers via an external storage medium, a network, or the like.

As another example of optimizing or improving the efficiency of the learning models performed by the machine learning device 100′, it is also assumed to analyze the distribution of the outputs of the respective learning models with respect to the input data according to a general statistical method, extract outliers of the sets of the input data and output data, and perform distillation using the sets of the input data and the output data excluding the outliers in the process of performing distillation with respect to the plurality of learning models acquired from the respective controllers 1. By undergoing such a process, it is possible to exclude exceptional estimated results from the sets of the input data and the output data obtained from the respective learning models and generate a distillation model using the sets of the input data and the output data excluding the exceptional estimated results. As the distillation model thus generated, a general-purpose distillation model for the robots 160 controlled by the controllers 1 may be generated from the learning models generated by the plurality of controllers 1.

Note that it is also possible to appropriately employ a method for optimizing or improving the efficiency of other general learning models (such as a method in which respective learning models are analyzed and the hyper parameters of the learning models are optimized on the basis of results of the analysis).

The system 170 according to the present embodiment allows an operation in which the machine learning device 100′ is arranged on the computer 5 serving as a fog computer installed with respect to the plurality of robots 160 (the controllers 1) serving as, for example, edge computers, learning models generated by the respective robots 160 (the controllers 1) are intensively stored on the fog computer, and a learning model optimized or made efficient is redistributed to the respective robots 160 (the controllers 1) as occasion demands after the optimization or the improvement in the efficiency of the plurality of learning models.

In addition, the system 170 according to the present embodiment allows an operation in which learning models intensively stored on the computer 5 serving as, for example, a fog computer and a learning model optimized or made efficient on the fog computer are collected into a still-higher host computer or a cloud server, and the learning models are applied to intellectual operations at factories or the manufacturers of the robots 160 (such as the construction and the redistribution of another general-purpose learning model at the higher server, the assistance of a maintenance operation on the basis of a result of the analysis of the learning model, the analysis of the performance of the like of the respective robots 160, and application to the development of new machines).

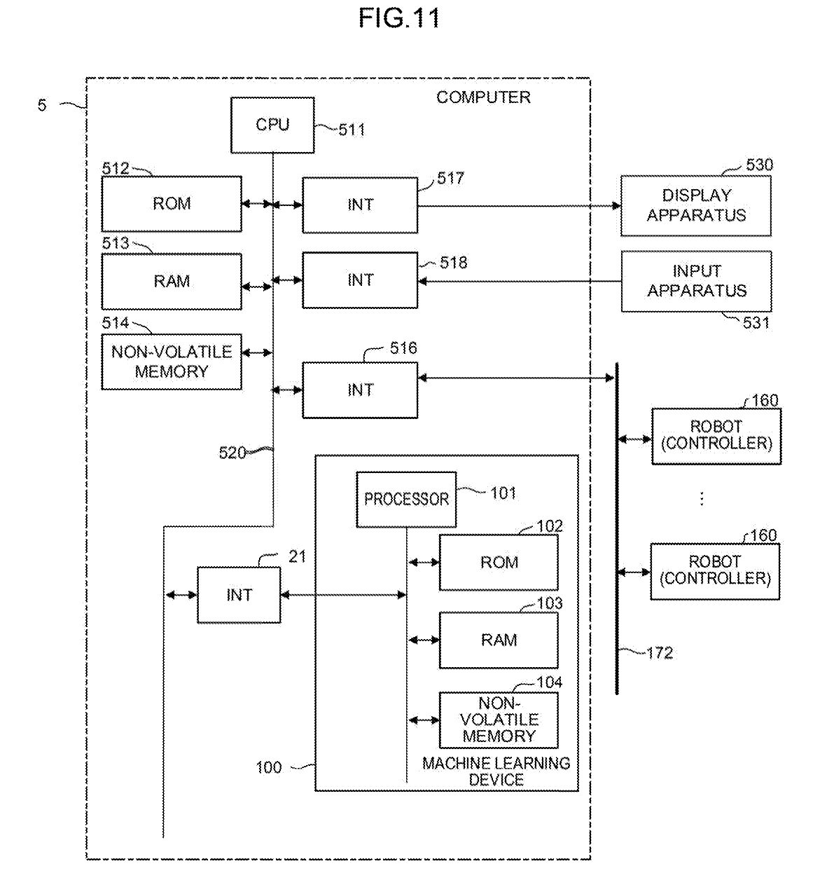

FIG. 11 is a schematic hardware configuration diagram of the computer 5 shown in FIG. 10.

A CPU 511 of the computer 5 is a processor that entirely controls the computer 5. The CPU 511 reads a system program stored in a ROM 512 via a bus 520 and controls the entire computer 5 according to the system program. In a RAM 513, temporary calculation data, various data input by an operator via an input apparatus 531, or the like is temporarily stored.

A non-volatile memory 514 is constituted by a memory backed up by, for example, a battery (not shown), an SSD (Solid State Drive), or the like and maintains its storage state even if the power of the computer 5 is turned off. The non-volatile memory 514 has a setting region in which setting information associated with the action of the computer 5 is stored. In the non-volatile memory 514, data input from the input apparatus 531, learning models acquired from (the controllers of) the respective robots 160, data read via an external storage apparatus (not shown) or a network, or the like is stored. A program or various data stored in the non-volatile memory 514 may be developed into the RAM 513 when run/used. In addition, in the ROM 512, a system program including a known analysis program for analyzing various data is written in advance.

The computer 5 is connected to the network 172 via an interface 516. At least one robot 160, other computers, or the like is connected to the network 172 and mutually exchanges data with the computer 5.

On a display apparatus 530, data obtained as a result of the execution of each data, a program, or the like read on a memory or the like is output and displayed via an interface 517. In addition, the input apparatus 531 constituted by a keyboard, a pointing device, or the like transfers a command based on an operation by an operator, data, or the like to the CPU 511 via an interface 518.

Note that the machine learning device 100 includes the same hardware configuration as that described with reference to FIG. 1 except that the machine learning device 100 is used to optimize or improve the efficiency of learning models in cooperation with the CPU 511 of the computer 5.

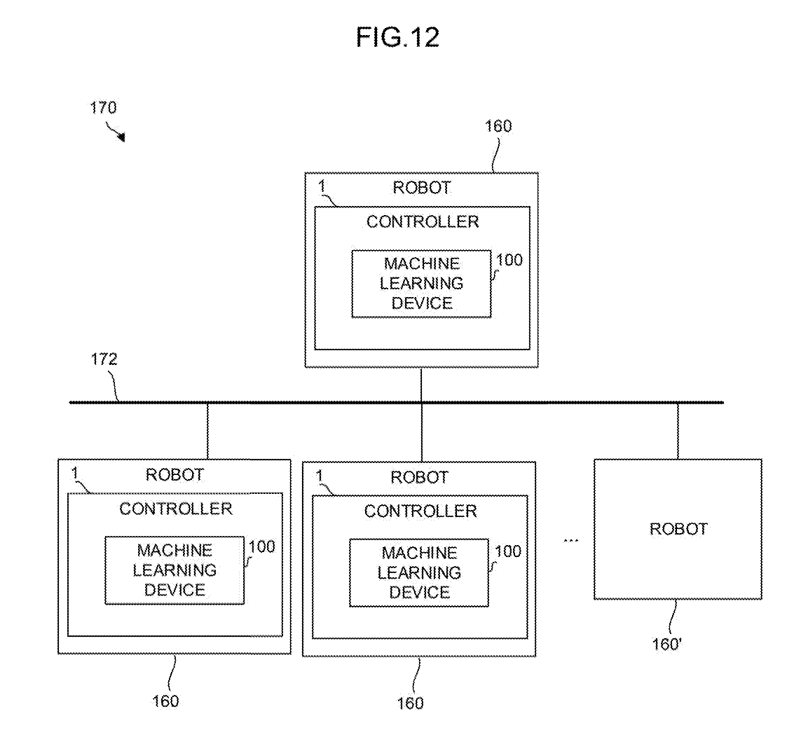

FIG. 12 shows the system 170 according to a sixth embodiment including the controllers 1. The system 170 includes the plurality of controllers 1 mounted as controllers (edge computers) that control the robots 160, a plurality of other robots 160 (controllers 1), and the wired/wireless network 172 that connects the plurality of controllers 1 and the plurality of other robots 160 to each other.

In the system 170 having the above configuration, the controllers 1 that include the machine learning devices 100 perform machine learning based on state data and determination data acquired from the robots 160 to be controlled and state data and determination data acquired from other robots 160′ (that do not include the machine learning devices 100) to generate a learning model. The learning model thus generated is used not only for the determination of the grinding conditions in the grinding action of the robots 160 controlled by the controllers 1 themselves but also for the determination of the grinding conditions in the grinding action of (the controllers) of other robots 160 in response to requests from other robots 160′ that do not include the machine learning devices 100. In addition, when the controller 1 that includes the machine learning device 100 before generating a learning model is newly introduced into the system 170, it is possible to acquire a learning model from another controller 1 that includes the learning model via the network 172 and use the same.

The system according to the present embodiment allows the common use of data or a learning model for learning between the plurality of robots 160 (the controllers 1) that serve as so-called edge computers. Therefore, an improvement in the efficiency of machine learning or a reduction in the cost of the machine learning (such as the common use of the machine learning device 100 with other robots 160 by the introduction of the machine learning device 100 into only one of the controllers (the controllers 1) that control the robots 160) is allowed.

The embodiments of the present invention are described above. However, the present invention is not limited to the examples of the above embodiments and may be carried out in various modes with the addition of appropriate modifications.

For example, a learning algorithm performed by the machine learning device 100 or the machine learning device 120, a calculation algorithm performed by the machine learning device 120, and a control algorithm performed by the controller 1 or the controller 2 are not limited to the above algorithms, but various algorithms may be employed.

In addition, it is described in the above embodiments that the controller 1 (or the controller 2) and the machine learning device 100 (or the machine learning device 120) have different CPUs, but the machine learning device 100 (or the machine learning device 120) may be realized by the CPU 11 of the controller 1 (or the controller 2) and the system program stored in the ROM 12.

1. A controller that controls a robot that performs grinding on a workpiece, the controller comprising:
a machine learning device that learns grinding conditions for performing the grinding, wherein
the machine learning device has
a state observation section that observes, as state variables expressing a current state of an environment, a feature of a surface state of the workpiece after the grinding and the grinding conditions,
a determination data acquisition section that acquires determination data indicating an evaluation result of the surface state of the workpiece after the grinding, and
a learning section that learns the feature of the surface state of the workpiece after the grinding and the grinding conditions in association with each other using the state variables and the determination data.

2. The controller according to claim 1, wherein
the grinding conditions among the state variables include at least one of rotation speed of a grinding tool, rotation torque of the grinding tool, pressing force of the grinding tool, and action speed of the robot, and
the determination data includes at least one of density of streaks on the surface of the workpiece after the grinding, smoothness of the streaks, and an interval between the streaks.

3. The controller according to claim 1, wherein
the learning section has
a reward calculation section that calculates a reward associated with the evaluation result, and
a value function update section that updates, using the reward, a function expressing a value of the grinding conditions with respect to the feature of the surface state of the workpiece after the grinding.

4. The controller according to claim 1, wherein
the learning section has
an error calculation section that calculates an error between a correlation model for deriving the grinding conditions for performing the grinding from the state variables and the determination data, and a correlation feature identified from teacher data prepared in advance, and
a model update section that updates the correlation model so as to reduce the error.

5. The controller according to claim 1, wherein
the learning section calculates the state variables and the determination data in a multilayer structure.

6. The controller according to claim 1, further comprising:
a decision-making section that outputs a command value based on the grinding conditions on the basis of a learning result of the learning section.

7. The controller according to claim 1, wherein
the learning section learns the grinding conditions using the state variables and the determination data obtained from a plurality of the robots.

8. The controller according to claim 1, wherein
the machine learning device is realized by an environment of cloud computing, fog computing, or edge computing.

9. A machine learning device that learns grinding conditions for performing grinding on a workpiece by a robot, the machine learning device comprising:
a state observation section that observes, as state variables expressing a current state of an environment, a feature of a surface state of the workpiece after the grinding and the grinding conditions;
a determination data acquisition section that acquires determination data indicating an evaluation result of the surface state of the workpiece after the grinding; and
a learning section that learns the feature of the surface state of the workpiece after the grinding and the grinding conditions in association with each other using the state variables and the determination data.

10. A system in which a plurality of apparatuses are connected to each other via a network, wherein
the plurality of apparatuses have a first robot including at least the controller according to claim 1.

11. The system according to claim 10, wherein
the plurality of apparatuses have a computer including a machine learning device,
the computer acquires at least one learning model generated by learning of the learning section of the controller, and
the machine learning device of the computer performs optimization or improves efficiency on the basis of the acquired learning model.

12. The system according to claim 10, wherein
the plurality of apparatuses have a second robot different from the first robot, and
a learning result of the learning section of the controller of the first robot is shared with the second robot.

13. The system according to claim 10, wherein
the plurality of apparatuses have a second robot different from the first robot, and
data observed by the second robot is available for learning by the learning section of the controller of the first robot via the network.
